(19) United States
(12) Patent Application Publication
(10) Pub. No.: US 2011/0267641 A1
(43) Pub. Date: Nov. 3, 2011

(54) Reprographic System Having Bluetooth Support for Offline Finishing Devices and DFA Devices

(76) Inventor: Raymond C. Stacy, Sodus, NY (US)

(21) Appl. No.: 12/770,023

(22) Filed: Apr. 29, 2010

(51) Int. Cl. G06F 3/12

(52) U.S. Cl. 358/1.15

(57) ABSTRACT

A reprographic system includes an image output terminal, an external finishing device or an offline finishing device, and Bluetooth^{SM} communications devices associated with the image output terminal and the external finishing device or the offline finishing device. The Bluetooth^{SM} communications device associated with the external finishing device or the offline finishing device automatically configures to communicate with the Bluetooth^{SM} communications device associated with the image output terminal, with the Bluetooth^{SM} communications devices defining a piconet. Print job offline finishing parameters entered at the image output terminal are transmitted by the Bluetooth^{SM} communications device associated with the image output terminal and received by the Bluetooth^{SM} communications device associated with the external finishing device or the offline finishing device. The external finishing device or the offline finishing device implements an offline task on the print job using the print job offline finishing parameters.

### BACKGROUND

This disclosure relates generally to reprographic, publishing, and imaging systems. More particularly, the present disclosure relates to systems and methods for enabling increased productivity in reprographic, publishing, and imaging systems having multiple finishing devices.

High end reprographic and electronic imaging systems generally include an image output terminal (IOT) providing documents to one or more document finishing devices (DFDs) and/or one or more external finishing devices (EFDs). In such systems, the IOT generally controls the scheduling and flow of documents to the DFDs and/or EFDs. However, there is no automated programming support for offline finishing devices or document finishing devices.

### SUMMARY

There is provided a reprographic system comprising an image output terminal and an external finishing device or an offline finishing device. Bluetooth^{SM} communications devices are associated with the image output terminal and the external finishing device or the offline finishing device. The Bluetooth^{SM} communications device associated with the external finishing device or the offline finishing device automatically configures to communicate with the Bluetooth^{SM} communications device associated with the image output terminal, with the Bluetooth^{SM} communications devices defining a piconet. Print job offline finishing parameters entered at the image output terminal are transmitted by the Bluetooth^{SM} communications device associated with the image output terminal and received by the Bluetooth^{SM} communications device associated with the external finishing device or the offline finishing device for use by the external finishing device or the offline finishing device.

A reader device adapted to read print job offline finishing parameters recorded on a job submission ticket may be associated with the image output terminal. Alternatively, an input/output device may be associated with the image output terminal to enter print job offline finishing parameters into the image output terminal.

The reprographic system may comprise multiple external finishing devices and multiple offline finishing devices.

There is also provided a method of operating a reprographic system having an image output terminal, a Bluetooth^{SM} communications device associated with the image output terminal, at least one external finishing device or offline finishing device, and a Bluetooth^{SM} communications device associated with the external finishing device or the offline finishing device, the Bluetooth^{SM} communications devices forming a piconet. The method comprises entering offline finishing parameters of a print job into the image output terminal. The external finishing devices or the offline finishing devices required to complete the print job in the print job specification are identified. If an identified external finishing device or offline finishing device is not part of the reprographic system, a new external finishing device or offline finishing device is added to the reprographic system by connecting the Bluetooth^{SM} communications device associated with the new external finishing device or offline finishing device to the piconet. The print job offline finishing parameters are transmitted from the image output terminal with a Bluetooth^{SM} communications device associated with the image output terminal and received at the external finishing device or the offline finishing device with a Bluetooth^{SM} communications device associated with the external finishing device or the offline finishing device. The external finishing device or the offline finishing device implements an offline task on the print job using the print job offline finishing parameters.

Entering offline finishing parameters of the print job into the image output terminal may comprise reading offline finishing parameters with a reader device associated with the image output terminal. The offline finishing parameters are stored in a format compatible with the reader device on a job submission ticket, which is submitted to the reader device.

The method may further comprise transmitting a task completion message from the external finishing device or the offline finishing device when the offline task has been completed. This includes generating the task completion message with the external finishing device or the offline finishing device, transmitting the task completion message from the image output terminal with the Bluetooth^{SM} communications device associated with the external finishing device or the offline finishing device, and receiving the task completion message at the image output terminal with the Bluetooth^{SM} communications device associated with the image output terminal.

### BRIEF DESCRIPTION OF THE DRAWINGS

The present disclosure may be better understood and its numerous objects and advantages will become apparent to those skilled in the art by reference to the accompanying drawings in which:

FIG. 1 is an exemplary conventional electronic printing or reprographic system;

FIG. 2 is a schematic diagram of a reprographic system having bluetooth support for offline finishing devices and DFA devices in accordance with the disclosure;

FIG. 3 is a flow diagram of a method of operating a reprographic system having bluetooth support for offline finishing devices and DFA devices in accordance with the disclosure.

### DETAILED DESCRIPTION

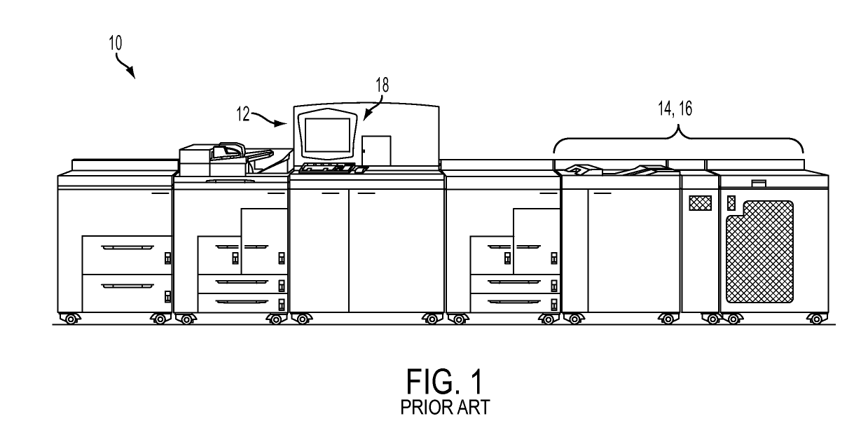

FIG. 1 shows one example of a conventional reprographic system 10. The reprographic system includes a printer or image output terminal (IOT) 12, a document finishing device (DFD) 14, and an external finishing device (EFD) 16. Finishing devices, DFDs and EFDs, can be devices such as, but not limited to, stackers, binders, staplers, stitchers, or any other finishing or paper handling device, or any combination of the foregoing.

In general, IOTs 12 include a marking engine, a raster output scanner (ROS) or line marking array, a paper transport and delivery system plus a bypass transport, machine controllers, and an electronic interface to a print service processor. IOTs 12 may further include a user interface 18, a maintenance interface, a video data buffer, a command buffer, a test pattern generator, stand-alone diagnostics, and billing meters, for example.

As used herein, “finishing” refers to any or all of a set of processes or operations applied to printed or imprinted documents. Finishing operations can include, for example, binding, stapling, varnishing, laminating, embossing, stripping, folding, collating, perforating, punching, stacking, and combinations thereof. Such operations can be applied to a set of documents.

Some finishing operations are performed inline, as shown in FIG. 1, with printing or production printing systems. In magazine or book printing, signatures are delivered from the printer or IOT 12 to the DFD 14 or EFD 16 that performs the document finishing such as by folding and binding (for example, by stapling) each set of documents. Inline DFDs 14 and EFDs 16 generally include a paper transport and delivery system, an electronic interface to interface with the IOT 12, mechanical latching mechanisms to latch with the IOT 12, and control electronics. Offline DFDs 14 and EFDs 16 do not include mechanical latching mechanisms to latch with the IOT 12 and may not include a paper delivery system or an electronic interface to interface with the IOT 12. DFDs 14 and EFDs 16 may further include finishing and feeding functions, a user interface, a maintenance interface, a test generator, stand-alone diagnostics, and billing meters, for example.

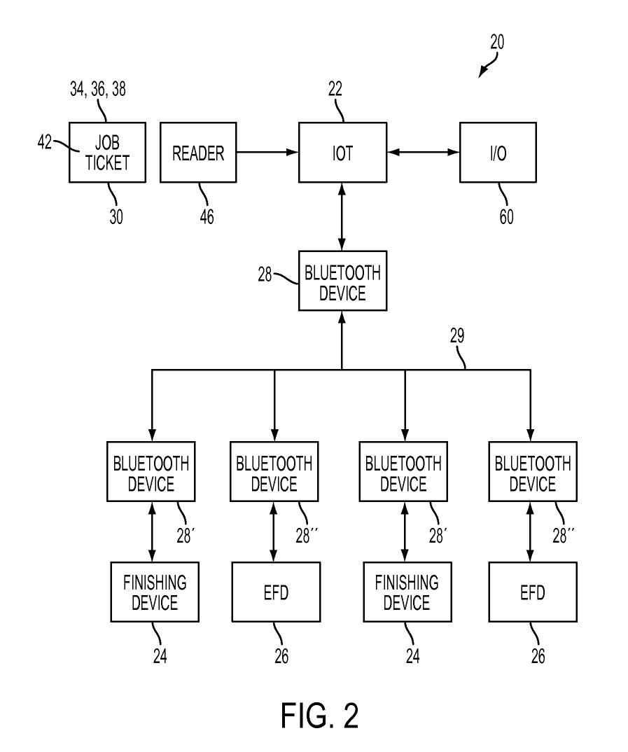

In the subject reprographic system 20 (FIG. 2), the IOT 22, the offline finishing devices 24 and the EFDs 26 (including EFDs having Xerox's Document Finishing Architecture (DFA)) are Bluetooth^{SM} enabled. That is, the IOT 12, the offline finishing devices 24, and the EFDs 26 all include or are associated with Bluetooth^{SM} communications devices 28, 28′, 28″.

Bluetooth^{SM} wireless technology is a short-range communications technology that provides high levels of security. The Bluetooth^{SM} specification defines a uniform structure for a wide range of devices 28, 28′, 28″ to connect and communicate with each other. Connections between Bluetooth^{SM} enabled electronic devices 28, 28′, 28″ allow these devices to communicate wirelessly through short-range, ad hoc networks known as piconets 29. Bluetooth^{SM} devices 28, 28′, 28″ avoid interference with other wireless devices by using a technique known as spread-spectrum frequency hopping and using low power wireless signals.

A Bluetooth^{SM} devise 28, 28′, 28″ can be designed to automatically configure itself. More specifically, when two or more Bluetooth^{SM} devices 28, 28′, 28″ connect, they automatically begin to communicate if authorized. This feature allows the offline finishing devices 24 and the EFDs 26 used in the reprographic system 20 to be changed without having to perform any reprogramming of the communications system. The offline finishing devices 24 and the EFDs 26 removed from the system 20 simply drop out of the piconet 29 and the offline finishing devices 24 and EFDs 26 added to the system 20 configure themselves automatically to the piconet 29. Connecting the new offline finishing devices 24 and EFDs 26 to the system 20 must be authorized to prevent random Bluetooth^{SM} devices from connecting to the system 20, but does not require any programming or data input.

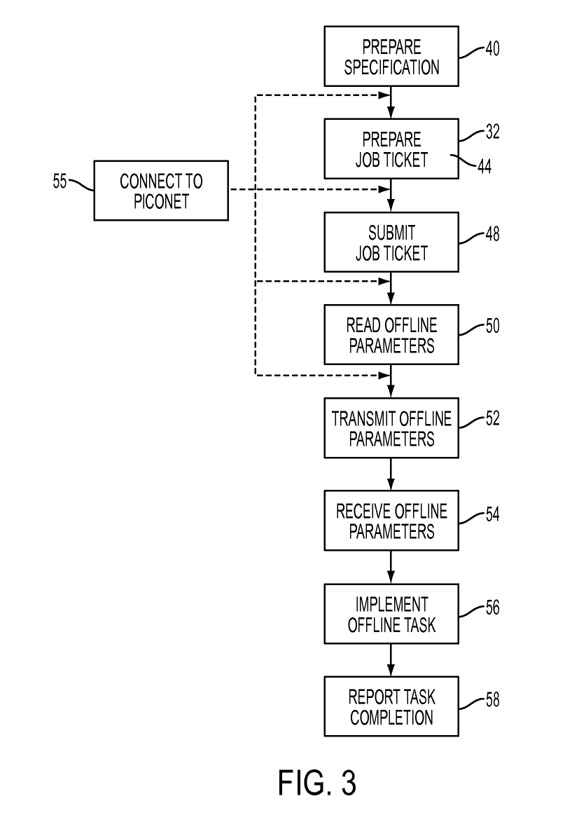

With additional reference to FIG. 3, a job submission ticket 30 prepared 32 for each job includes a print job specification 34, comprising the online printing parameters 36 and the offline finishing parameters 38 for the print job. The print job specification 34 may be prepared 40 prior to preparation 32 of the job submission ticket 30 or concurrently with preparation 32 of the job submission ticket 30. In either case, the print job specification 34 and a unique print job identifier 42 are stored 44 on the job submission ticket 30, in a format that may be read by a reader device 46 associated with the IOT 22, when the job submission ticket 30 is prepared 32. When the print job is submitted 48, the reader device 46 reads 50 the print job specification 34. The offline finishing devices 24 and/or the EFDs 26 that are required to complete the print job may be identified in the print job specification 34 or the IOT 22 may assign the offline finishing devices 24 and/or the EFDs 26 that are required to complete the print job based on the offline finishing parameters 38. The IOT 22 transmits 52 the offline finishing parameters 38 to the offline finishing devices 24 and/or the EFDs 26, using Bluetooth^{SM} communications device 28, and are received 54 by the Bluetooth^{SM} communications devices 28′, 28″ associated with the identified offline finishing device 24/EFD 26. If an identified offline finishing device 24/EFD 26 is not part of the reprographic system 20, the identified offline finishing device 24/EFD 26 can be added to the reprographic system 20 by connecting 55 the Bluetooth^{SM} communications device 28 associated with the new offline finishing device 24/EFD 26 to the piconet 29. This may be done anytime before the IOT 22 transmits 52 the offline finishing parameters 38 to the to the new offline finishing device 24/EFD 26. The offline finishing device 24 or the EFD 26 performs 56 its task(s) in accordance with the offline finishing parameters 38 when the print job arrives for finishing. When the offline finishing device 24 or the EFD 26 has completed its task, it reports 58 that it has completed its task to the IOT 22 through the Bluetooth^{SM} devices 18, 18′, 18″. It should be appreciated that the print job specification 34 is manually inputted only a single time, when it is initially prepared 40, allowing for review of the specification 34 and elimination of input errors.

If a reader device 46 is not associated with the IOT 22, the print job specification 34 and print job identifier 42 are manually entered into the IOT 22 using the input/output device (I/O) 60. Although this is less efficient than reading 50 the print job specification 34 and print job identifier 42 with a reader device 46, the Bluetooth^{SM} communications between the IOT 22 and the offline finishing devices 24 and/or the EFDs 26 eliminates the need to enter the offline finishing parameters 38 into those devices.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A reprographic system comprising:
an image output terminal;
a bluetooth communications device associated with the image output terminal;
an external finishing device or an offline finishing device; and
a bluetooth communications device associated with the external finishing device or the offline finishing device;
wherein the bluetooth communications device associated with the external finishing device or the offline finishing device automatically configures to communicate with the bluetooth communications device associated with the image output terminal, the bluetooth communications device associated with the image output terminal and the bluetooth communications device associated with the external finishing device or the offline finishing device defining a piconet, print job offline finishing parameters entered at the image output terminal being transmitted by the bluetooth communications device associated with the image output terminal over the piconet to the bluetooth communications device associated with the external finishing device or the offline finishing device for use by the external finishing device or the offline finishing device.

2. The reprographic system of claim 1 further comprising a reader device associated with the image output terminal, the reader device being adapted to read print job offline finishing parameters recorded on a job submission ticket.

3. The reprographic system of claim 1 further comprising an input/output device associated with the image output terminal, the input/output device being adapted to enter print job offline finishing parameters into the image output terminal.

4. The reprographic system of claim 1 further comprising a plurality of external finishing devices or offline finishing devices.

5. The reprographic system of claim 1 further comprising a plurality of external finishing devices and offline finishing devices.

6. A method of operating a reprographic system having an image output terminal, a bluetooth communications device associated with the image output terminal, at least one external finishing device or offline finishing device, and a bluetooth communications device associated with the external finishing device or the offline finishing device, the bluetooth communications devices forming a piconet, the method comprising:
entering offline finishing parameters of a print job into the image output terminal;
identifying the external finishing devices or the offline finishing devices required to complete the print job in the print job specification;
adding a new external finishing device or offline finishing device to the reprographic system if an identified external finishing device or offline finishing device is not part of the reprographic system by connecting the bluetooth communications device associated with the new external finishing device or offline finishing device to the piconet;
transmitting the print job offline finishing parameters from the image output terminal with a bluetooth communications device associated with the image output terminal;
receiving the print job offline finishing parameters at the external finishing device or the offline finishing device with a bluetooth communications device associated with the external finishing device or the offline finishing device; and
implementing an offline task on the print job with the external finishing device or the offline finishing device using the print job offline finishing parameters.

7. The method of claim 6 wherein entering offline finishing parameters of the print job into the image output terminal comprises reading offline finishing parameters with a reader device associated with the image output terminal.

8. The method of claim 7 further comprising:
storing offline finishing parameters in a format compatible with the reader device on a job submission ticket; and
submitting the job submission ticket to the reader device.

9. The method of claim 8 further comprising:
preparing a print job specification including offline finishing parameters; and
storing the print job specification in a format compatible with the reader device on the job submission ticket.

10. The method of claim 8 wherein the reprographic system includes a plurality of external finishing devices or a plurality of offline finishing devices, the method further comprising the image output terminal assigning the external finishing devices or the offline finishing devices required to complete the print job based on the offline finishing parameters.

11. The method of claim 6 wherein entering offline finishing parameters of the print job into the image output terminal comprises manually entering the offline finishing parameters with an input/output device associated with the image output terminal.

12. The method of claim 6 further comprising transmitting a task completion message from the external finishing device or the offline finishing device when the offline task has been completed.

13. The method of claim 12 wherein transmitting a task completion message includes:
generating the task completion message with the external finishing device or the offline finishing device;
transmitting the task completion message from the image output terminal with the bluetooth communications device associated with the external finishing device or the offline finishing device; and
receiving the task completion message at the image output terminal with the bluetooth communications device associated with the image output terminal.

14. A method of operating a reprographic system having an image output terminal, at least one external finishing device, a bluetooth communications device associated with the external finishing device, at least one offline finishing device, a bluetooth communications device associated with the offline finishing device, the bluetooth communications devices forming a piconet, the method comprising:
entering offline finishing parameters of a print job into the image output terminal;
identifying the external finishing devices and the offline finishing devices required to complete the print job;
adding a new external finishing device or offline finishing device to the reprographic system if an identified external finishing device or offline finishing device is not part of the reprographic system by connecting the bluetooth communications device associated with the new external finishing device or offline finishing device to the piconet;
transmitting the print job offline finishing parameters from the image output terminal with the bluetooth communications device associated with the image output terminal;
receiving the print job offline finishing parameters at the identified external finishing devices and the identified offline finishing device with the bluetooth communications device associated with the external finishing devices and the offline finishing devices;
implementing an offline task on the print job with the external finishing device or the offline finishing device using the print job offline finishing parameters; and
transmitting a task completion message from the identified external finishing devices and the identified offline finishing devices when the offline tasks have been completed.

15. The method of claim 14 further comprising:
preparing a print job specification including offline finishing parameters;
storing the print job specification in a format compatible with a reader device associated with the image output terminal on a job submission ticket; and
submitting the job submission ticket to the reader device.

16. The method of claim 15 wherein identifying the external finishing devices and the offline finishing devices required to complete the print job includes recording the identified external finishing devices and the identified offline finishing devices in the print job specification.

17. The method of claim 15 wherein identifying the external finishing devices and the offline finishing devices required to complete the print job includes assigning the external finishing devices and the offline finishing devices with the image output terminal.

18. The method of claim 14 wherein transmitting a task completion message includes
generating the task completion message with the external finishing device or the offline finishing device;
transmitting the task completion message from the image output terminal with the bluetooth communications device associated with the external finishing device or the offline finishing device; and
receiving the task completion message at the image output terminal with the bluetooth communications device associated with the image output terminal.
